(19) United States
(12) Patent Application Publication
(10) Pub. No.: US 2013/0010266 A1
(43) Pub. Date: Jan. 10, 2013

(54) Compact Projector Head

(75) Inventors: Kjell Einar Olsen, Krakeroy (NO); Per-Kristian Thogersen, Torp (NO); Hans Erik Davidsen, Sarpsborg (NO); Sverre Lefsaker, Versteroy (NO); Jorn Eriksen, Versteroy (NO)

(73) Assignee: projectiondesign as, San Francisco, CA (US)

(21) Appl. No.: 13/176,553

(22) Filed: Jul. 5, 2011

(51) Int. Cl. G03B 21/16; G03B 21/00

(52) U.S. Cl. 353/52; 353/121

(57) ABSTRACT

Systems methods and apparatus for projection system including a control/illumination module and a separate projector head are disclosed. The control/illumination module can be disposed in the location separate from location in which the projector head is disposed and/or used. The projector head can be coupled to the control/illumination module via a control signal connection, and illumination transmission connection and an optional coolant connection. By separating the control/illumination module from the projector head module, many, if not all, noise and heat producing elements can be implemented in the control/illumination module, thus providing a smaller sized, quieter, efficient and lower maintenance projector head that can be installed in implementations in which extraneous noise, heat, and leaked light can be detrimental to the viewing experience.

### BACKGROUND

Embodiments described herein are related to the field of image projection. Traditionally image projection includes projection of moving and still images from in front of or behind a display surface from various types of image projectors. Such image projectors include traditional film projectors as well as digital projectors. Typically, digital projectors include a digital image device or micro-display, such as DMD, LCOS, LCD or other similar devices, control circuitry, a light source, a color generating optical engine, projection optics and a power supply all contained in a single device or housing. The inclusion of such a large number of components in a single housing presents designers and users of such digital projectors with various problems and drawbacks.

The inclusion of a power supply, control circuitry, a light source, and other active elements within any singular housing of a digital projector presents designers and users with size, noise, and heat management and dissipation issues. For example, a power supply used for converting electricity from AC to DC currents to run the control circuitry and the light source alone can generate a great deal of heat that must be dealt with in order to avoid damage to the other components included in the digital projector. Additionally, many high-intensity light sources, such as arc lamps and other discharge based illumination sources, can also generate a great amount of waste heat that must be dissipated or handled. Many traditional digital projectors include various forms of heat handling elements, such as motorized fans and bulky heat sink modules that are included in the digital projector solely for the purpose of dealing with unwanted heat generation.

While many designs have been developed using fans and heat sink modules, the size and number of such elements that must be included in a digital projector can cause undesirable increases to the size, noise and cost of such devices. For example, to adequately dissipate the heat generated by the various components of digital projector, the projector may need to include several fans to circulate air through or over the various heat generating components and heat sinks. Digital projectors that include fans usually also include intake and exhaust vents in the projector body to aid in the ventilation of the heat. Such intake and exhaust fans present configuration problems including the possibility of light leaking from the digital projector body, the possibility of increased fan noise, and the potential for introducing dust onto the sensitive electronic and optical components contained in the digital projector housing.

While various solutions exist for obviating the issues and problems present with the use of motorized fans with intake and exhaust air vents in a digital projector, such as sophisticated quiet fans, light baffling and dust seals, most of the presently available solutions often involve the addition of increased complexity, bulk, weight, size and cost for producing a digital projector with the desired performance specifications. A digital projector can include fewer fans by increasing the number of heat sink elements coupled to the heat generating components of the digital projector, but such a solution is simply a trade-off that oftentimes includes the addition of weight and bulk to the resulting digital projector.

Embodiments described herein, individually and in combination with one another, address these issues and problems, and include various other advantages.

### BRIEF SUMMARY

Embodiments described herein are directed toward projection systems that can include a control module that has an illumination source and a display device driver, and a separate projector head coupled to the control module via a control signal connection. The projector head can include an enclosed body member, a heat sink structure disposed inside and coupled to the enclosed body module, and a display device coupled to the heat sink structure. The body member can also include a power module disposed inside the enclosed body module and coupled to the heat sink structure. In some embodiments, the enclosed body module can be hermetically sealed or include other heat sink structures on an exterior surface of the enclosed body member. In other embodiments, the control module of the projection system can also include a power module to supply power to the projector head via a power connection.

In many embodiments, the projection system is arranged or installed such that the control module is operated in one location and the projector head is operated in another location and the two modules are connected via a plurality of connections that span the distance between the two locations. For example, a control signal connection and an illumination transmission connection traverse a distance between one room and another room.

In other embodiments, the projection system can include a control module that also includes a cooling module coupled to the projector head via a coolant connection. The heat sink structure disposed inside the enclosed body module can include channels or grooves to receive coolant received from the cooling modules via the coolant connection to cool the various components and modules in the projector head. In many of the embodiments described herein projector head includes only solid-state components so as to minimize the number of moving parts and noise generating components.

Other embodiments are directed toward projector heads that can include enclosed thermally conductive body members, heat sink structures disposed inside and coupled to the body module, display devices coupled to the heat sink structures, optical engines coupled to the display devices, and illumination transmission connection couplers devices coupled to the optical engines or the display devices. Such projector heads can also include control signal connection coupler devices coupled to the display device to deliver control signals to the display device received from a remote control/illumination module.

In yet other embodiments, the projector heads can also include electrical transceiver modules coupled between the control signal coupler devices and the display devices and coupled to the heat sink structures. Such projector heads can also include a serializer-deserializer (SerDes) coupled between the control signal connection coupler device and the display device to deserialize serialized control and driver signals received from a remote control/illumination module via a control signal connection. Additionally, the projector heads can include an electrical-optical converter module coupled between control signal connection coupler device and the SerDes for instances in which the control or driver signals are received via an optical connection such as a fiber optic or optical cable link from the remote control/illumination module.

Finally, some embodiments are directed toward projector heads in which the enclosed thermally conductive body member, the heat sink structure, the display device, the optical engine each include only solid-state components with no moving parts, so as to minimize the number of moving parts and the related maintenance. Such projector heads can advantageously include a coolant coupler device to receive coolant via a coolant connection from a remote control module that has a cooling module.

A better understanding of the nature and advantages of embodiments of the present invention may be gained with reference to the following detailed description and the accompanying drawings.

### BRIEF DESCRIPTION OF THE DRAWINGS

FIG. 1 is a schematic of a projector system according to various embodiments.

FIG. 2 is a schematic of a projector system according to various embodiments with separate control and illumination modules.

FIG. 3 is a schematic of a control/illumination module for a projection system according to various embodiments.

FIG. 4 is a schematic of a projector head for a projection system according to various embodiments.

FIG. 5 illustrates a configuration for projecting images using a projection system according to various embodiments.

FIG. 6 is a flowchart of a method for using a projector system according to various embodiments.

### DETAILED DESCRIPTION

Embodiments of the present invention are directed towards projection systems and image and video projectors. Specifically, various embodiments are directed toward compact and quiet projection systems that include separate control modules and projector heads that can be installed in different rooms or locations. To reduce the size and the number of moving parts and heat producing elements in the projector head, control structures and functionality, power circuitry and the illumination source can be located in a control module located in a remote location and connected to the protector head via a control signal connection, an illumination transmission connection and power supply connection. Some embodiments include a cooling module that can circulate coolant to the projector head to cool the various component via a coolant connection.

The various connections can span the distance between the location where the control module is located or installed and the location in which the projector head is located or installed. This separation is useful for isolating noise, heat, and light that might otherwise have a detrimental effect on the performance of the projection system, as well as provide for a number of advantages.

For example, the reduced size and quiet projector head can be installed in a movie theater, viewing room or convention hall, while the control module that provides control signals, power and illumination via the connections, can be located or installed in another room. The reduction in the size of the projector head can provide for a more sleek and compact projector installation in locations where space is limited or the presence of extraneous sound, heat or light is undesirable or otherwise detrimental. In such embodiments, the residual heat generated from the operation of a display device and other necessary circuitry in the projector head can be dissipated silently using solid-state heat sinks. In such embodiments, all of the components, modules, device and circuits can be solid-state and include no moving parts. For additional space savings, the housing of the projector head itself can be designed to include various heat sink materials and structures.

Meanwhile, the heat and noise associated with the operation of the control circuitry, power supply, illumination source, and heat dissipation and cooling systems can be handled efficiently in the remote location with fewer considerations with respect to size, aesthetics, noise, light leaks, and heat in ways that might otherwise interfere with projections systems performance or a user's viewing experience. In some embodiments, the control module can be located in an environmentally controlled and/or soundproofed room to optimize the performance of the projection system.

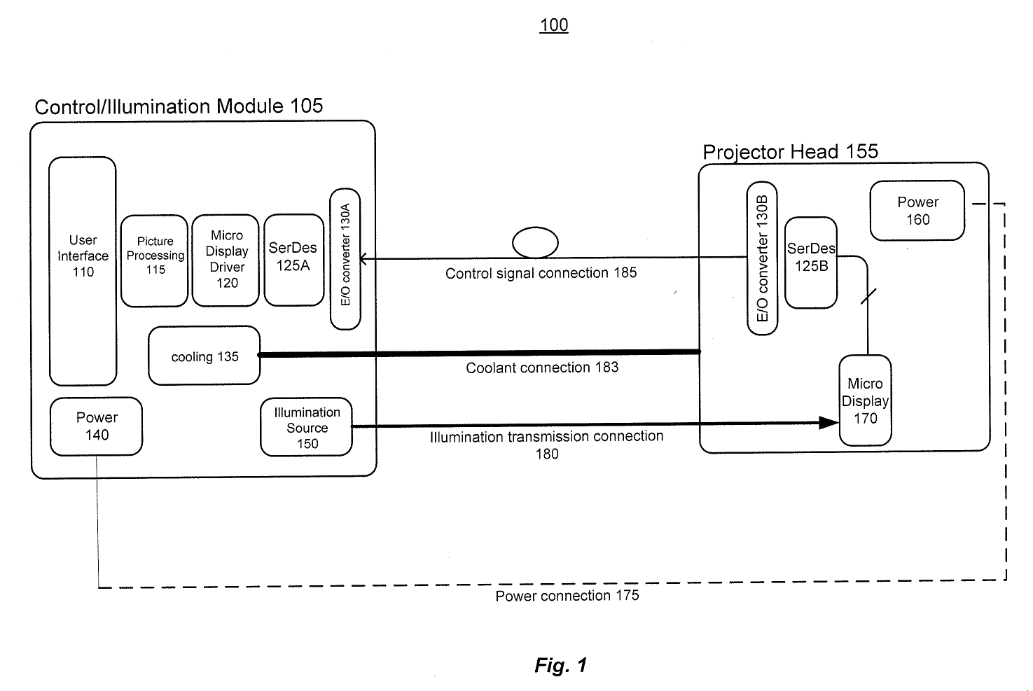

Various embodiments will be described with reference to specific examples of projection systems, projectors, projection modules and projection components as depicted in FIGS. 1 through 5. The depiction of the embodiments in the figures and the description of embodiments in reference to those figures are intended to be illustrative only, and in no way should the specific example shown and described be consider limiting. Elements from each embodiment can be combined with other elements from other embodiments without departing from the spirit and scope of the present invention.

FIG. 1 is a schematic of a projection system 100 according to various embodiments. In such embodiments, the projection system 100 can include a control module/illumination module 105 and projector head or projection module 155. As used herein, the terms projector head and projection module can be used interchangeably to refer to the portion of the system that includes at least a micro-display 170. Control module/illumination module 105 and projector head or projection module 155 can be coupled by a plurality of connections. The connections can include a control signal connection 185 to relay control or driver signals between the control/illumination module 105 and projector head 155. The connections can also include a coolant connection 183 for exchanging coolant between the control/illumination module 105 and the projector head 155 for cooling at least some of the components of the projector head 105. In some embodiments, the connections can include an illumination transmission connection 180 for providing illumination from an illumination source 150 to the projector head 155. Illumination source 150 can be integrated or separate from control/illumination module 105. Each connection can include a connection coupler device to couple the connection to a corresponding coupler device on the control/illumination module, illumination source, or projector head or to one or more of the components or modules therein.

As shown, control/illumination module 105 can include a user interface module 110, a picture processing model 115, a micro-display driver module 120, SerDes module 125A, and electrical-optical converter (E/O converter) 130A, a power module 140, an illumination source 150 and an optional cooling module 135. Each one of the modules in control/illumination module 105 can be coupled to or included in any of the other modules in control/illumination module 105. The coupling between the various modules can be achieved in a number of ways including, but not limited to, electrical and optical signal connectors. For example, all the modules in control/illumination module 105 can be connected to a common bus, circuit board or a combination thereof that includes one or more common buses or circuit boards.

In related embodiments, the user interface module 110 can include any number of user interface components or elements such as a keyboard, a touchscreen, a touchpad, a keypad, buttons, switches, levers, and sliders that the user can use or manipulate to activate, operate and otherwise use the projection system 100, control/illumination module 105 or projector head 155.

In some embodiments, user-interface 110 can include a remote control or wireless interface to provide users with the ability to interact with and control control/illumination module 105, and any component coupled therero, remotely. Examples of such remote control interfaces can include, but are not limited to, infrared remote control interfaces, radiofrequency (RF) remote control interfaces, wireless local area network (WLAN) interfaces, or local area network (LAN) interfaces. Such interfaces can include receivers, transmitters, transponders, and transceivers implemented in various combinations of hardware, software, and firmware. For example, the remote control interface can include a transceiver that complies with IEEE 802.11 type wireless networking protocols.

As shown, some embodiments of control/illumination module 105 can include a picture processing module 115. Picture processing module 115 can include a number of image processing and image source modules. Such image processing and image source modules, included in picture processing module 115 or some other module of the control/illumination module 115, can include a processor and a memory, such as a non-transitory computer readable medium. The memory or non-transitory computer readable medium can include machine readable or executable code or instructions that when executed by the processor can cause the picture proceeding module 115, or other module in the control/illumination module, to operate, command or control the projection system 100. The operation of the projection system can include various user interface functionality to control the user interface 110.

For example, picture processing module 115 can include a processor, a memory and a communication interface for retrieving, storing, and processing image data the can be sent to micro-display driver 120. The communication interface of picture processing module 115 can include an input/output port or other interface for accepting image data from another device. Such devices can include a computer readable storage medium, such as flash memory, as well as optical drives, hard drives, local and remote computers, digital video or still cameras, and other portable and stationary computing devices.

In some embodiments, user interface module 110 or picture processing module 115 can include a peripheral connection to provide for a direct wired connection between various peripheral devices, memory devices and computer readable media that store and/or provide digital image data. For example the peripheral connection can include USB, IEEE 1394, parallel, serial, and other standard and proprietary wired connectors. Once picture processing module 115, or some other module, retrieves and/or receives image data, it can perform various image processing steps to convert the image data into appropriate signals to be sent to the micro-display driver 120.

The micro-display driver 120 can be a general-purpose micro-display driver or one specifically paired with the image device or micro-display 170 in the projection head module 155. In either case, micro-display driver 120 can convert the image data received from the picture processing module 115 into appropriate signals usable by and/or recognizable by micro-display 170. Since the control/illumination module 105 is separated from the projector head module 155 in which micro-display 170 is located, some embodiments include a SerDes 125A that can receive the signals from the micro-display driver 120, serialize the signals and send the serialized signal to electrical to optical converter (E/O converter) 130A. E/O converter 130A can convert electrical signals from the SerDes 125A into optical signals for transmission across control signal connection 185 the corresponding E/O converter 130B. In such embodiments, the control signal connection 185 can include an optical fiber for optical cable.

In some embodiments, E/O converters 130A and 130B can be omitted if the control signal connection 185 is an electrical connection between SerDes 125A and SerDes 125B. In such embodiments, control signal connection 185 can include proprietary or standard electrical connections including, but not limited to, parallel and serial communication standards. In such embodiments, it may be possible to omit SerDes 125A and 125B. However, as shown in FIG. 1, the control signal sent via E/O converter 130A and control signal connection 185 and received by E/O converter 130B can be deserialized by SerDes 125B and sent to micro-display 170 in projector head 155. Micro-display 170 can include, but is not limited to, conventional proprietary LCD, LCOS, DMD, and other reflective, polarization manipulating, and reflective micro-displays. As used herein, the terms image device and micro-display can be used interchangeably to refer to various types of devices suitable for producing images that can be projected with or without an optical engine.

The picture elements, i.e. pixels, of micro-display 170 can thus be arranged and/or operated to manipulate the illumination received by illumination transmission connection 180 from illumination source 150 in control/illumination module 105. In such embodiments, illumination transmission connection 180 can include a light pipe, optical fiber or optical cable to guide illumination from illumination source 150 to the micro-display 170 and any accompanying color creation and optical engine components coupled to micro-display 170.

In some embodiments, the illumination source module 150 can include various spectral shaping or conditioning optical components as well as heat management optics. For example, the illumination source module 150 can include absorptive and /or interference type infrared filters or hot mirrors for reducing the amount of infrared radiation, and consequently heat, transmitted over illumination transmission connection 180 to micro-display 170 and projection head 155. Similarly, illumination source module 150 can also include absorptive, reflective, and/or interference type spectral shaping filters to specifically tailor the illumination provided by illumination source 150 to match or complement the color producing components included in or coupled to micro-display 170.

In yet other embodiments, the illumination source module 150 can include various color producing components that micro-display 170 can use to produce high-quality color digital images for projection. In any embodiment, the spectral response and transmission characteristics of illumination transmission connection 180 can be taken into consideration when implementing various color management and color producing optical components. For instance the color producing optical components included in or coupled to illumination source 150, micro-display 170, or other module, can be designed to complement and/or compensate for the spectral transmission characteristics of illumination transmission connection 180.

In some embodiments, control/illumination module 105 can include a power module 140 to provide power to projector head 155 via power connection 175. In such embodiments, projector head 155 can include a power module 160 to manage, convert and distribute power received from power module 140 to the components of projector head 155. For example, power module 140 may supply an AC electrical power to power module 160. Power module 160 can then down-convert or up-convert the AC electric power to DC electrical power of various voltages and currents to the components in projector head 155.

In yet other embodiments, control/illumination module 105 can include a cooling module 135. Cooling module 135 can include various heat management components for extracting heat from projector head 155 and its various components. In such embodiments, cooling module 135 can include various gaseous and liquid coolants that can be circulated via ducted or ductless distribution channels or grooves within the enclosed body member or heat sink structures that receive the coolant in projection head 155. For example, cooling module 135 can include a pump for circulating liquid coolant via coolant connection 183 to a system of tubes or ducts coupled to the various components and heat exchangers in the body of projector head 155. In such embodiments, coolant connection 183 can include a number of send and return channels or tubes to exchange liquid coolant between coolant module 135 and projector head 155.

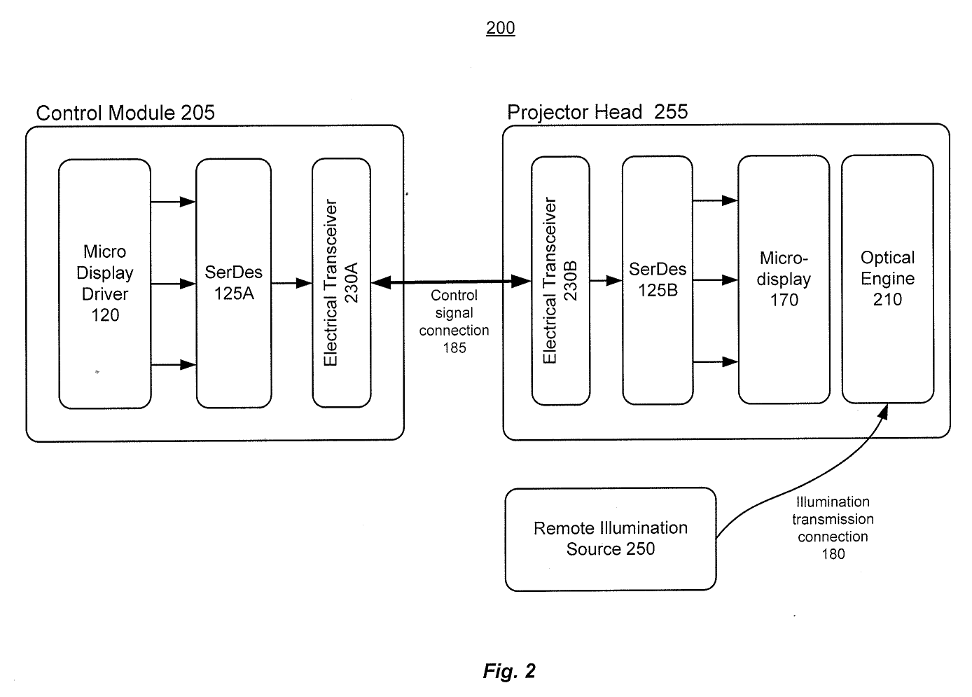

FIG. 2 shows another embodiment of the present invention hat can include separate control and illumination modules. System 200 shown in FIG. 2 can include a control module 206, projector head 255 and a separate remote illumination source module 250. Such embodiments are similar to the system 100 illustrated in FIG. 1, but with a separate and possibly remote illumination source 250. Providing remote illumination source module 250 separately from control module 206 can decrease light and electrical noise management that might otherwise need to be included in control module 205 to compensate for the presence of illumination source in the control module 205. Such embodiments can allow for simplified, efficient and cost-effective design, implementation and maintenance of control module 205.

Separating remote illumination source module 250 from control module 205 advantageously provides for flexibility of installation and ease of placement of the module for routine maintenance of remote illumination source 250. For example, it may be desirable for remote illumination source module 250 to be located where a user can easily access the module to operate, maintain, repair or replace components in the illumination source module 250. In such embodiments, heat, noise, and the light can be separately handled apart from the components within control module 205. Illumination provided by remote illumination source module 250 can be delivered to the optical engine 210 within projector head 255 by illumination transmission connection 180.

The components in control module 205 can include a micro-display driver 120 coupled to a SerDes 125A and an electrical transceiver 230A. Micro-display driver 120 and SerDes 125A can include similar functionality and components as described above in reference to system 100 in FIG. 1. Accordingly, SerDes 125A can serialize control or driver signals provided by micro-display driver 120. Electrical transceiver 230A can communicate or send the serialized control or driver signals to projector head 255 via control signal connection 185. The control or driver signals sent from electrical transceiver 230A can be received by electrical transceiver 230B. Electrical transceiver 230B can send the serialized control signal received from control module 205 to SerDes 125B. SerDes 125B can deserialize the serialized control signals received by electrical transceiver 230B and send the deserialized control signal to micro-display 170. Micro-display 170 can thus be operated using the control or driver signals to produce images.

Micro-display 170 can be coupled to optical engine 210 to produce and project still and moving protected images. Optical engine 210 can include a number of optical components for color creation, optical correction, spectral conditioning and shaping, and projection. For example, optical engine 210 can include an optical train including optics for illuminating micro-display 170 as well as projection optics for projecting images produced by micro-display 170. Optical engine 210 can also include color management and/or color production optical components. Such color management and color production components can include polarization or color beam splitting prisms, absorptive, reflective or interference type optical filters that can be configured in stationary or moving configurations, such as a rotating color wheel. In one embodiment, projector head 155 of system 100 can also have an optical engine.

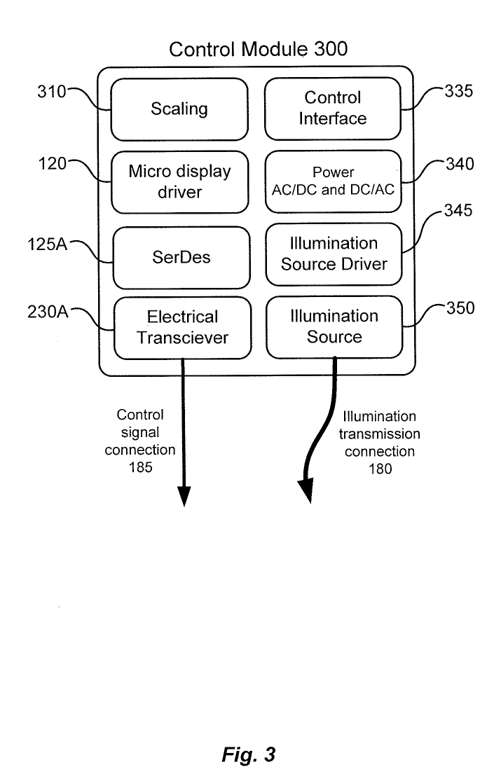

FIG. 3 shows a control module 300 according to various embodiments of the present invention. As shown, control module 300 can include a scaling module 310, micro-display driver module 120, SerDes 125A, electrical transceiver module 230A, control interface module 335, power module 340, illumination source driver module 345, and illumination source module 350. Micro-display driver 120 and SerDes 125A can include similar functionality and components as described above in reference to systems 100 and 200 in FIGS. 1 and 2.

Scaling module 310 can size, stretch, skew, reformat, or otherwise alter the size, shape, aspect ratio and other dimensional characteristics of the image data received from one or more sources coupled to control interface 335. The image data received via control interface 335 can be received in an aspect ratio different from the aspect ratio of the micro-display in the connected or associated projector head. Scaling module 310 can alter the image data to provide micro-display driver 120 with image data that the corresponding micro-display can project. For example, control interface 335 may receive image data from a personal computer in 4:3 VGA aspect ratio and resolution. However, the micro-display in the corresponding projector head may be an HD 16:9 aspect ratio micro-display. In such cases, scaling module 310 can zoom or clip the image data. Micro-display driver 120 can then send the control signals including the altered or unaltered image data received from scaling module 310 to SerDes 125A for serialization. The serialized control signal can then be fed to electrical transceiver 230A for transmission over control signal connection 185 to the corresponding projector head.

Control interface module 335 of control module 300 can include a number of input and outputs ports and connections for receiving user input, image data or interacting with image data sources. The input and output ports and connections can include various data, network, and image and sound specific connectors and interfaces. For example, control interface can include a number of HD, video, and computer display ports and connections, including HDMI, DVI, VGA, SVGA, XGA connections, as well as other standard and high definition video format connections and interfaces. Control interface module 335 can also include various user interface components and functionality similar to those described in reference to user interface 110 in FIG. 1.

Power module 340 can include components and functionality similar to power module 140 discussed in reference to FIG. 1. Power module 340 can also include AC/DC and DC/AC electrical power conversion capabilities, as well as other power conditioning functionality, such as voltage and current conversion to supply appropriate power to the various components within control module 300.

Control module 300 can also include an illumination source driver module 345. Illumination source driver module 345 can include functionality for controlling illumination source module 350. For example, illumination source driver module 345 can receive image/video data/information from scaling module 310, micro-display driver 120, SerDes 125A or other components of control module 300. Illumination source driver module 345 can use the image/video data/information to control illumination source module 350 to produce specific illumination characteristics. In embodiments in which illumination source module 350 includes multiple lamps, changeable color filters, apertures and other spectral shaping components, illumination source driver module 345 can operate illumination source module 350 with specific intensity, spectral characteristics or numerical aperture.

Illumination source driver module 345 can work in combination with illumination source 350 to provide illumination via illumination transmission connection 180 to complement a working connection with the micro-display in a projector head to which control module 300 is connected. This functionality of illumination source driver module 345 can be particularly useful if illumination source module 350 is modular or interchangeable depending on the specific requirements of the micro-display and optical engine in the projector head to which control module 300 is connected. Illumination source driver module 345 can be used to specify the operation of illumination source module 350 to provide illumination with specific spectral and optical characteristics.

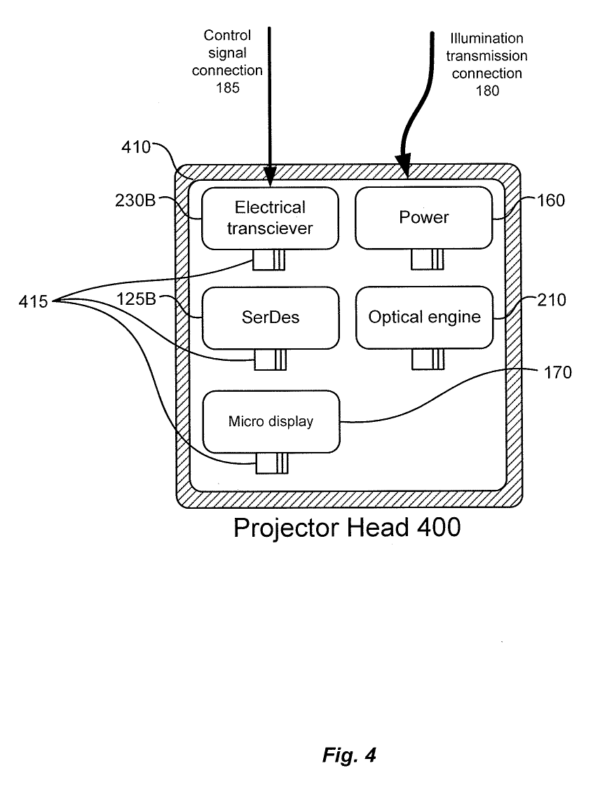

FIG. 4 shows a projector head 400 according to various embodiments of the present invention. As shown projector head 400 includes a body member 410. Shown within body 410, is an exemplary collection of various projector head components including, but not limited to, electrical transceiver 230B, SerDes 125B, power module 160, micro-display 170 and optical engine 210. Each of the components shown in projector head 400 can include components and functionality similar to those discussed above in reference to similarly numbered components in reference to FIGS. 1 and 2.

In some embodiments, body member 410 can include or be made of thermally conductive material such as metal. Any or all of the components included within body member 410 can be thermally and/or electrically coupled two the interior of body member 410. In such embodiments, each component can be coupled to body member 410 via one or more heat sink elements 415. Heat sink elements 415 can be made of or include various thermally conductive materials as well as include various heat sink physical characteristics or structures such as spines, fins, and other structures to increase the overall surface area in contact with the atmosphere within body member 410 or with the surfaces of body member 410. In embodiments in which the control/illumination module includes an optional cooling module, the interior of body member 410 can include ducted or ductless liquid or gaseous coolant. In such embodiments, heat sink elements 415 can include channels or fins to increase the surface area exposed to the coolant material.

Body member 410 can also include various heat sink structures and materials to increase the surface area of the exterior a body member 410 to further increase the efficiency of the heat dissipation and heat sink elements within body member 410. For example, body member 410 can include fins and/or spines on its exterior to increase surface area, and thus the heat exchange area, for dissipating heat conducted from the various components within body member 410 through heat sink elements 415 to the atmosphere external to body member 410. In such embodiments, it is preferable to omit extraneous moving parts, such as fans and pumps, so as to avoid extraneous noise and reduce the amount of maintenance required for operating projector head 400. As such, projector head 400 can be operated silently as it, the optical engine 210 and other components within body member 410 include only solid-state components and include no moving parts. While in some other embodiments, optical engine can include a spinning color wheel, it is still possible to reduce the sound emitted by the projector head 400 by reducing the need for or at least the number of extraneous cooling fans and pumps.

In some embodiments, body member 410 can be enclosed to be light tight, air tight, dust resistant, and/or hermetically sealed. In such embodiments, the projector head 400 can be entirely light tight to avoid leaked light from diminishing the projected image, while also reducing the chance that contaminants will settle on micro-display 170, optical engine 210, or any other components within body member 410. Such embodiments advantageously provide a compact, maintenance-free projector head that can be installed the viewing environment or extraneous light and sound would diminish the viewing experience.

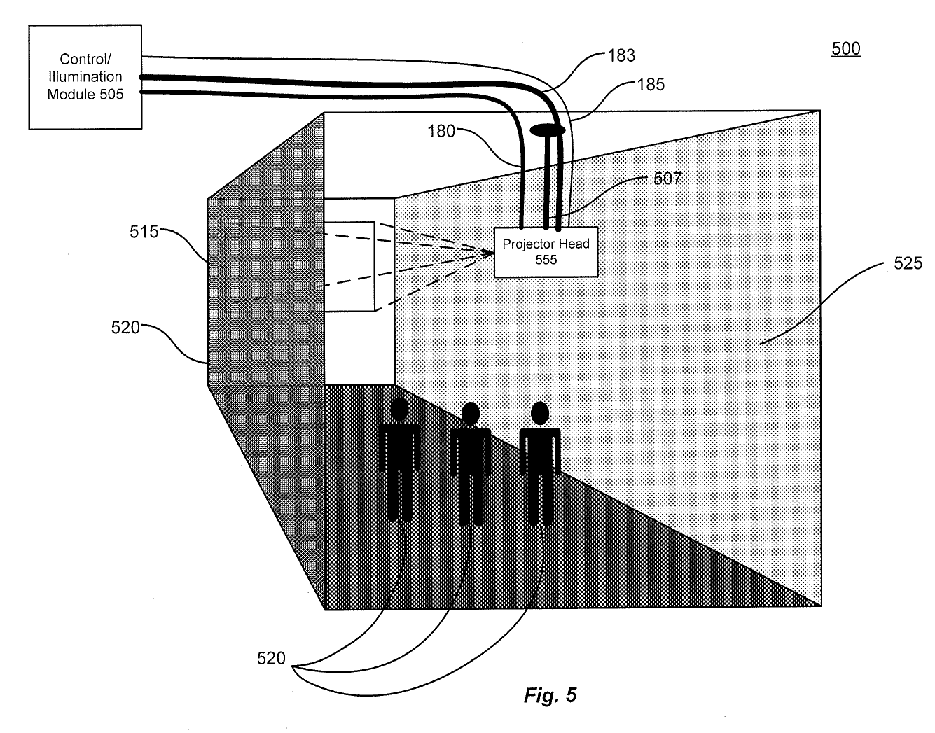

FIG. 5 shows an exemplary system 500 that can include various embodiments of the present invention. System 500 can include a location 520, such as a movie theater or a viewing room. System 500 can include an interior volume 525 and a projection surface 515 on one or more surfaces within the interior volume 525. As shown, projector head 555 can be mounted to an interior surface of interior volume 525 via mounting element such as hang bar 507. While projector head 555 is shown as being mounted to the ceiling surface of the interior volume 525, projector head 555 can be mounted to any other surface or object within interior volume 525 without departing from the spirit or scope of the present invention. In this example, projector head 555 is oriented to project an image onto a projection surface 515 in front of an audience of viewers 520. As shown in FIG. 5, control/illumination module 505 is located in location external to location 520. Control/illumination module 505 can be coupled to projector head 555 via control signal connection 185, coolant connection 183, and illumination transmission connection 180.

In such embodiments, the size of projector head 555 can be greatly reduced by removing extraneous components and locating them within control/illumination module 505. Not only does the size of projector have 555 get reduced by removing the illumination source, control circuitry, and the power supply, but the noise level and the number of heat producing elements within projector head 555 can be greatly reduced. Thus, projector head 555 can be operated near silently while also having excellent heat dissipation attributes.

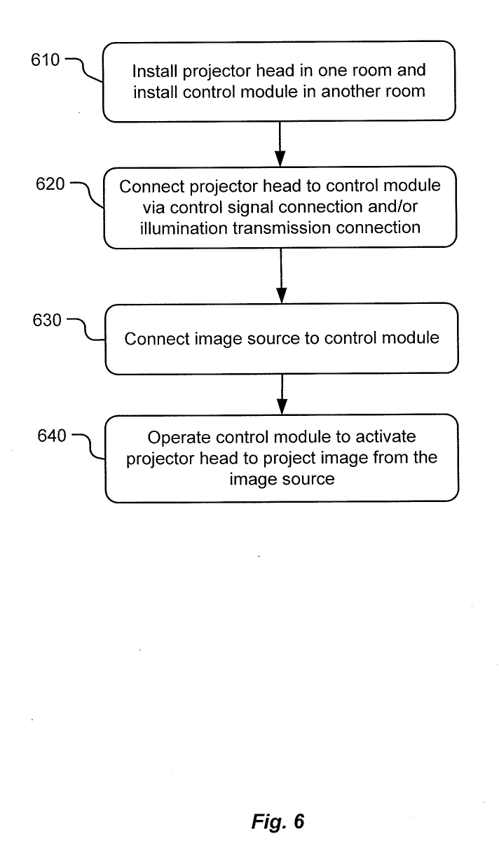

FIG. 6 is a flowchart of a method of implementing a projection system according to various embodiments of the present invention. The method begins at action 610 in which a projector head is installed in one room or location while the control module is installed another room or location. The separation of the projector head from the control module allows noise and heat producing and management elements, i.e. fans, coolant pumps, power supplies, light sources, control circuitry, etc., to be located within the control/illumination module in a location other than that in which the projector head is located. The control/illumination module can then be connected or coupled to the projector head via various connections, in action 620. As described herein, such connections can include an optical or electrical control signal connection, optical illumination transmission connection, and an optional coolant connection.

Once the illumination session control module is connected to the projector head by the various connections, a user can connect an image source to the control module to provide image data to the projection system in action 630. The image source can include various types of still and moving digital image data stored on or produced by various memory devices, peripheral devices, cameras, and other equipment. Any type of device capable of providing digital image data can be connected, either directly or wirelessly, to the control/illumination module. For example, the control/illumination control module can be directly connected to a playback device such as a DVD player or computer. In other embodiments, the control/mission control module can be connected via wireless or wired LAN to a video server computer located at a location remote to and separate from the control/illumination module or the projector head.

Next, once an image source is connected to or in communication with the control/illumination module, a user can operate the control/illumination module to activate the projector head to project an image on a projection surface based on the data received a retrieved the image source.

A recitation of “a”, “an” or “the” is intended to mean “one or more” unless specifically indicated to the contrary.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

What is claimed is:

1. A projection system comprising:
a control module comprising:
an illumination source; and
a display device driver; and
a projector head coupled to the control module via a control signal connection, wherein the projector head comprises:
an enclosed body member;
a heat sink structure disposed inside and coupled to the enclosed body member; and
a display device coupled to the heat sink structure.

2. The projection system of claim 1 further comprising a power module disposed inside the enclosed body member and coupled to the heat sink structure or other heat sink structure.

3. The projection system of claim 1 wherein the enclosed body member is hermetically sealed.

4. The projection system of claim 1 wherein the enclosed body member comprises other heat sink structures on an exterior surface of the enclosed body member.

5. The projection system of claim 1 wherein the control module further comprises a power module to supply power to the projector head via a power connection.

6. The projection system of claim 1 wherein the control module is operated in a first location and the projector head is operated in a second location, and the control signal connection and the optical transmission connection traverse a distance between the first location and the second location.

7. The projection system of claim 1 wherein the control module further comprises a cooling module coupled to the projector head via a coolant connection.

8. The projection system of claim 7 wherein the heat sink structure disposed inside the enclosed body module comprises channels to receive coolant received from the cooling modules via the coolant connection.

9. The projection system of claim 1 wherein the projection head only includes electronics that are solid-state.

10. A projector head comprising:
an enclosed thermally conductive body member;
a heat sink structure disposed inside and coupled to the body module;
a display device coupled to the heat sink structure;
an optical engine coupled to the display device; and
an illumination coupler device for receiving light from an external illumination device, the illumination coupler device being coupled to the display device and/or the optical engine and providing the received light to the display device and/or the optical engine.

11. The projector head of claim 10 further comprising a control signal connection coupler device for receiving control signals from an external control module, the control signal coupler device being coupled to the display device and providing the received control signals to the display device.

12. The projector head of claim 11 further comprising an electrical transceiver module coupled between the control signal coupler device and the display device and coupled to the heat sink structure.

13. The projector head of claim 11 further comprising a serializer-deserializer (SerDes) coupled between the control signal connection coupler device and the display device.

14. The projector head of claim 13 further comprising an electrical-optical converter module coupled between control signal connection coupler device and the SerDes.

15. The projector head of claim 10 wherein the enclosed thermally conductive body member, the heat sink structure, the display device, the optical engine each include only solid-state components with no moving parts.

16. The projector head of claim 10 further comprising a coolant coupler device to receive coolant via a coolant connection from a control module located in a remote location.

17. The projector head of claim 16 wherein the coolant coupler device is coupled to channels in the heat sink structure.

18. The projector head of claim 10 wherein the optical engine comprises a projection lens.

19. The projector head of claim 18 wherein the optical engine further comprises color creating optical components.

20. A method for operating a projector head comprising an enclosed thermally conductive body member, a heat sink structure disposed inside and coupled to the body module, a display device coupled to the heat sink structure, an optical engine coupled to the display device, an illumination coupler device for receiving light from an external illumination device, the illumination coupler device being coupled to the display device and/or the optical engine and providing the received light to the display device and/or the optical engine, and a control signal connection coupler device for receiving control signals from an external control module, the control signal coupler device being coupled to the display device and providing the received control signals to the display device, the method comprising,:
receiving control signals from the external control module at the display device via the control signal coupler device;
receiving light from the external illumination device via the illumination coupler device;
projecting an image from the display device to a projection surface using the optical engine.

21. The method of claim 20 wherein the optical engine comprises color producing optical components, and receiving the light comprises passing the received light through the color producing optical components before sending the light to the display device.

22. The method of 21 further comprising conducting heat from the display device through the heat sink to the body member.
